(19) United States
(12) Patent Application Publication
(10) Pub. No.: US 2011/0194608 A1
(43) Pub. Date: Aug. 11, 2011

(54) Managing Predicted Motion Vector Candidates

(76) Inventors: Thomas Rusert, Kista (SE); Jacob Ström, Stockholm (SE); Kenneth Andersson, Gavle (SE); Per Wennersten, Arsta (SE); Rickard Sjöberg, Stockholm (SE)

(21) Appl. No.: 13/022,133

(22) Filed: Feb. 7, 2011

Related U.S. Application Data
(60) Provisional application No. 61/301,649, filed on Feb. 5, 2010.

(30) Foreign Application Priority Data
Dec. 23, 2010 (EP) PCT/EP2010/070680

(51) Int. Cl. H04N 7/12

(52) U.S. Cl. 375/240.16; 375/E07.104; 375/E07.105; 375/E07.243

(57) ABSTRACT

There is provided a method of managing PMV candidates. The method comprises selecting a set of PMV candidates as a subset of the previously coded motion vectors. The method further comprises assigning a code value to each PMV candidate in the set of PMV candidates. The code values vary in length and are assigned to the PMV candidates in order of expected usage such that the PMV candidate having the highest expected usage has one of the shortest code values.

### TECHNICAL FIELD

The present application relates to a method of managing PMV candidates, a video encoding apparatus, a video decoding apparatus, and a computer-readable medium.

### BACKGROUND

Recent video coding standards are based on the hybrid coding principle, which comprises motion compensated temporal prediction of video frames and coding of frame residual signals. For efficient motion compensated temporal prediction, block-based motion models are used to describe the motion of pixel blocks across frames. Each motion compensation block is assigned one motion vector (for uni-predictive temporal prediction, such as in P frames) or two motion vectors (for bi-predictive temporal prediction, such as in B frames). These motion vectors are coded in the video bit stream along with the frame residual signals.

At high compression ratios (or equivalently, low video bitrates), motion vector coding takes a large part of the total amount of bits, especially in recent video coding standards such as H.264/AVC where small motion compensation block sizes are used. Typically, lossless predictive coding of motion vectors is used, i.e. coding of a motion vector MV consists of first building a motion vector predictor PMV for the vector to be coded and then transmitting the difference, DMV, where DMV=MV−PMV between the motion vector and the motion vector predictor.

In H.264/AVC, a PMV is derived as the median of the motion vectors of three spatially neighboring blocks. Other approaches consider also temporally neighboring blocks (i.e. co-located in neighboring frames) for motion vector prediction. Instead of using a fixed rule for building PMV, recently approaches have been presented that explicitly signal a PMV to be used out of a set of PMV candidates, PMV_CANDS. Although this requires additional bits to signal one candidate out of the set, it can overall save bits for motion vector coding, since DMV coding can be more efficient. That is, identifying a PMV and signaling DMV can take fewer bits than independently signaling the MV.

The efficiency of motion vector coding schemes which use PMV candidate signaling depends on the suitability of the available candidates in PMV_CANDS. That is, the construction of the candidate list has a major impact on the coding performance. Existing approaches typically use motion vectors from spatially surrounding blocks or temporally neighboring blocks (co-located blocks in neighboring frames). Such construction of PMV_CANDS, i.e. considering only the few surrounding blocks as a source of motion vector predictors, can be sub-optimal.

The number of candidates in PMV_CANDS, i.e. the “length” of PMV_CANDS, has a major impact on coding efficiency, too. The reason is that the higher the number of candidates, the higher the number of bits required for signaling one of the candidates, which in turn causes additional overhead and thus reduced compression efficiency. Existing approaches assume a fixed number of candidates in PMV_CANDS (e.g. the spatially neighboring motion vectors) valid for coding of a video frame or sequence, and the number of candidates may only be reduced if some of the candidates are identical.

Motion vector coding can require a significant proportion of an available bitrate in video coding. Improving the number of PMV candidates may reduce the size of the difference value (DMV) that must be signaled but requires more signaling to identify the particular PMV. Accordingly, to improve video coding efficiency an improved method and apparatus for managing PMV candidates is required.

“An efficient motion vector coding scheme based on minimum bitrate prediction” by Sung Deuk Kim and Jong Beom Ra, published in IEEE Trans. Image Proc., Volume 8, Issue 8, August 1999 Page(s):1117-1120; describes a motion vector coding technique based on minimum bitrate prediction. A predicted motion vector is chosen from the three causal neighboring motion vectors so that it can produce a minimum bitrate in motion vector difference coding. Then the prediction error, or motion vector difference, and the mode information for determining the predicted motion vector at a decoder are coded and transmitted in order.

“Competition-Based Scheme for Motion Vector Selection and Coding” by Joel Jung and Guillaume Laroche, documented by the Video Coding Experts Group (VCEG) of ITU—Telecommunications Standardization Sector, and having document number VCEG-AC06, Klagenfurt, Austria, July 2006; describes a method for the reduction of the motion information cost in video coding. Two modifications made on the selection of the motion vector predictor are disclosed: improvement of the prediction of the motion vectors that need to be transmitted; and a Skip mode to increase the number of macro-blocks that do not require any motion information to be sent.

US 2009/0129464 in the name of Jung et al. relates to adaptive coding and decoding. This document describes a method of transmitting an image portion, whereby in a coding phase analyzing a coding context, a parameter of a group of prediction functions that can be used for coding is adapted. A first predicted descriptor is formed using a selected prediction function. A residue between the first predicted descriptor and the current descriptor is determined and transmitted.

### SUMMARY

There is provided a method of managing PMV candidates. The method comprises selecting a set of PMV candidates as a subset of the previously coded motion vectors. The method further comprises assigning a code value to each PMV candidate in the set of PMV candidates. The code values vary in length and are assigned to the PMV candidates in order of expected usage such that the PMV candidate having the highest expected usage has one of the shortest code values.

The above method allows for more frequently used PMV candidates to be signaled using fewer bits. This provides an increase in coding efficiency.

The code values assigned to each PMV candidate may comprise any code system which produces code words with varying lengths. For example, the code values may be assigned according to at least one of: arithmetic coding; Variable Length Coding; and Context-Based Adaptive Arithmetic Coding.

Any unnecessary PMV candidates may be removed from the set of PMV candidates. This ensures the length of the list is not unnecessarily long, which would reduce coding efficiency. A PMV candidate may be determined to be unnecessary if it at least one of the following conditions is fulfilled: the PMV candidate is a duplicate of another PMV candidate in the set; the PMV candidate is determined to be within a threshold distance of an existing PMV candidate; and the PMV candidate would never be used because at least one alternative PMV candidate will allow motion vectors to be coded using fewer bits.

Further, a set of PMV candidates may be determined to be unnecessary if removing them from the list of PMV candidates would result in at most N extra bits being required to encode any single motion vector, wherein N is a predetermined threshold. Removing a set of PMV candidates from the list of PMV candidates allows the remaining PMV candidates to be signaled using shorter codes and so fewer bits. However, removing a set of PMV candidates from the list of PMV candidates will result in some motion vectors having a larger difference vector, which will require more bits to encode. Over the average of several motion vectors, the saving in signaling which PMV candidate to use can exceed the at most, N extra bits required to signal some motion vectors.

Prior to the assigning of code values, the PMV candidates in the set of PMV candidates may be sorted according to expected usage of PMV. Subsequently, code values may be assigned to the PMV candidates in the sorted list. The code values may be assigned in order of the sorted entries such that the length of the assigned code values is non-decreasing with increasing position of the PMV candidate in the list.

PMV candidates may be identified by a scan pattern applied to the set of previously coded blocks. The scan pattern may identify particular blocks. The scan pattern may be arranged in order of expected usage. The scan pattern may be arranged in increasing order of distance of each identified block from the current block.

Each PMV candidate may correspond to a motion vector used for coding of a previous block, said previous block having a distance from a current block. The code values may be assigned to the PMV candidates in order according to the distances of their respective previous blocks from a current block.

The distance may be measured as a Euclidean distance or as a Chebyshev distance. The Euclidean distance can be found by taking the square root of the sum of the squares of the difference in x positions and y positions between the current block and the previous block. Ordering according to Euclidean distance can be performed by ordering by Euclidean distance squared, the square root function does not affect the ordering. Manhattan distance is given by the sum of the absolute values of: the difference in x coordinates of the current block and the previous block; and the difference in y coordinates of the current block and the previous block. Chebyshev distance is defined as the larger of two values, the first being the absolute value of the difference in x coordinates of the current block and the previous block and the second being the absolute value of the difference in the y coordinates of the current block and the previous block.

The PMV candidates may be ordered first according to Chebyshev distance and then PMV candidates having the same Chebyshev distance may be ordered further according to Euclidean distance. This allows for efficient ordering of the PMV candidates.

The method may be employed for video encoding or for video decoding, wherein the current block is the block being encoded or decoded respectively.

There is further provided a video encoding apparatus comprising a processor arranged to select a set of PMV candidates as a subset of the previously coded motion vectors. The processor is further arranged to assign a code value to each PMV candidate in the set of PMV candidates, wherein the code values vary in length and are assigned to the PMV candidates in order of expected usage such that the PMV candidate having the highest expected usage has one of the shortest code values.

There is further provided a video decoding apparatus comprising a processor arranged to select a set of PMV candidates as a subset of the previously coded motion vectors. The processor is further arranged to assign a code value to each PMV candidate in the set of PMV candidates, wherein the code values vary in length and are assigned to the PMV candidates in order of expected usage such that the PMV candidate having the highest expected usage has one of the shortest code values.

There is further provided a computer-readable medium, carrying instructions, which, when executed by computer logic, causes said computer logic to carry out any of the methods disclosed herein.

There are provided herein a plurality of methods for building lists of PMV candidates: PMV_CANDS. The candidates in PMV_CANDS are sorted, and the use of one of the candidates in PMV_CANDS is signaled from the encoder to the decoder. The signaling is arranged such that the first candidate in the list is assigned the shortest code word among the candidates and that subsequent candidates in the list are assigned code words with non-decreasing length (it is apparent that any other equivalent mapping of candidates on code words could be likewise applied). Then, using a combination of several methods, the set of PMV_CANDS is constructed such that candidates that are most beneficial for prediction are arranged towards the beginning of the list. Also, using these methods, the candidates in the list are selected such that they allow for efficient coding of motion vectors, and if only few such candidates are available, then the size of the list is reduced such that the code words for signaling use of a candidate can be reduced in length. Finally, methods for efficient signaling of use of PMV candidates are presented.

Further, there is provided a method of coding a motion vector, the method comprising: identifying a set of PMV candidates; determining a particular PMV candidate has coordinate values such that for a motion vector with x coordinates or y coordinates less than the coordinate values of the particular PMV candidate, an alternative PMV candidate in the set of PMV candidates can code the motion vector using fewer bits; determining a motion vector is to be coded using the particular PMV candidate; calculating a difference vector as the difference between the motion vector and the particular PMV; and coding the difference vector without coding a sign bit.

Yet further still, there is provided a method of decoding a motion vector, the method comprising: receiving the identity of a PMV candidate; receiving a difference value without a sign bit; determining a plurality of potential motion vectors based on the possible sign values of the difference value; determining the lowest bit cost solution for encoding the identified potential motion vectors using the available PMV candidates; and selecting the motion vector which uses the identified PMV candidate. Where a DMV is received containing one difference value without a sign bit, two potential motion vectors are found. Where a DMV is received containing two difference values without a sign bit, four potential motion vectors are found.

By application of this method, some situations are identified whereby the sign of a difference component (xdiff or ydiff) can only take one value. This can be done because the system selects a PMV candidate which minimizes the bit cost. If the sign of a difference component is unknown then there are two possible motion vectors. In some situations the system can identify that one of the motion vectors would be coded with a minimum bit cost using the indicated PMV, but the other motion vector would be coded with a minimum bit cost using a different PMV. Thus, the system can identify the sign of the difference as the sign that gives the motion vector would be coded with a minimum bit cost using the indicated PMV. Thus, for certain PMV candidates a sign bit on at least one of the difference components does not need to be transmitted, reducing the bit cost and improving coding efficiency.

### BRIEF DESCRIPTION OF THE DRAWINGS

An improved method and apparatus for managing PMV candidates will now be described, by way of example only, with reference to the accompanying drawings, in which:

FIG. 1 shows a video coding and transmission system;

FIGS. 2a and 2b show the use of a PMV candidate list during encoding and decoding respectively;

FIG. 3 shows an example of two PMV candidates;

FIG. 4 shows the bit cost of coding motion vectors using the example motion vectors of FIG. 3; and

FIG. 5 illustrates a method disclosed herein.

### DETAILED DESCRIPTION

FIG. 1 shows a video coding system wherein a video signal from a source 110 is ultimately delivered to a device 160. The video signal from source 110 is passed through an encoder 120 containing a processor 125. The encoder 120 applies an encoding process to the video signal to create an encoded video stream. The encoded video stream is sent to a transmitter 130 where it may receive further processing, such as packetization, prior to transmission. A receiver 140 receives the transmitted encoded video stream and passes this to a decoder 150. Decoder 150 contains a processor 155, which is employed in decoding the encoded video stream. The decoder 150 outputs a decoded video stream to the device 160.

The methods disclosed herein are performed in the encoder during encoding, and also in the decoder during decoding. This is achieved even though the generation of the signaling bits is done in the encoder. During decoding the decoder parses the bits and mimics the encoder in order to achieve encoder/decoder synchronization. Because the encoder and decoder follow the same rules for creating and modifying the set of PMV candidates, the respective lists of PMV candidates stored in the encoder and decoder maintain synchronization. Still, explicit signaling of PMV candidate lists may be performed under certain circumstances.

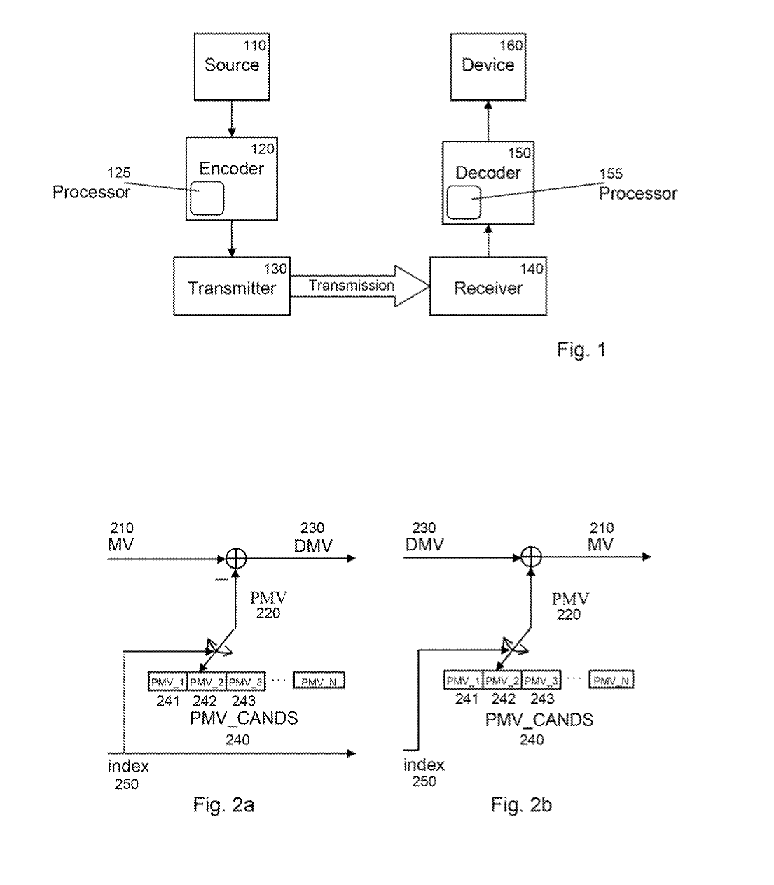

The described methods assume coding of a motion vector (MV) 210 using predictive coding techniques, where a predicted motion vector (PMV) 220 is used to predict a MV 210, and the prediction error or difference (DMV) 230 is found according to DMV=MV−PMV. DMV 230 is signaled from the encoder 120 to the decoder 150. Additionally, a code “index” 250 is sent to select a particular PMV candidate, in this case 242 from a list of PMV candidates, PMV_CANDS 240 as shown in FIG. 2a. The index 250 may be sent once together with each transmitted motion vector MV 210, i.e. per sub-block (e.g. 8×8 pixel block). Likewise, the index may be sent for groups of motion vectors, e.g. per macroblock (16×16 block).

The list of PMV candidates, PMV_CANDS (240) has N elements PMV_1 (241), PMV_2 (242), PMV_3 (243) etc. The list PMV_CANDS 240 is identically available at both the encoder 120 and the decoder 150. Using the transmitted index, the decoder 150 can determine the PMV 220 as used in the encoder as shown in FIG. 2b, and thus may reconstruct MV=DMV+PMV.

There are two major operations used for construction of the set of PMV candidates 240, initialization and update.

Initialization means that a certain pre-defined state of the list is established. A PMV_CANDS list may be initialized e.g. as an empty list (zero entries) or as a list with one or more pre-defined entries such as the zero vector (0,0). Update means that one or more motion vectors are added to an existing PMV_CANDS list. A PMV_CANDS list may be updated to include previously coded motion vectors MV. At the encoder, when encoding a current block, PMV_CANDS may contain, besides any pre-defined initialization vectors, motion vectors associated with previously encoded blocks in the video. By restricting the possible candidates in PMV_CANDS to pre-defined vectors and previously coded vectors, the decoder can derive the list PMV_CANDS in the same way as the encoder.

Alternatively, one or more motion vector candidates that have not been encoded previously may be added into the PMV_CANDS list at the encoder, and then those motion vectors will be explicitly signaled to the decoder for use with PMV_CANDS, such that PMV_CANDS can be updated in the same way both at the encoder and the decoder.

The PMV_CANDS list used for coding a motion vector MV associated with a current motion compensation block can be dynamically generated specifically for the current motion compensation block, i.e. without consideration of the PMV_CANDS lists used for coding of MVs associated with motion compensation blocks previously coded. In that case, before a block is processed, a PMV_CANDS list is initialized and then updated with a number of previously coded or pre-defined motion vectors. Alternatively, a PMV_CANDS list may be initialized once (for example before the start of video encoding/decoder, or before a frame is processed or after a number of macroblocks have been encoded in a frame), and then used for coding of more than one motion vector, the advantage being that the possibly complex process of deriving the PMV_CANDS list need only be processed once for coding of a set of motion vectors. When being used for coding of more than one motion vector, the PMV_CANDS list may however be updated after coding one of the motion vectors. For example, the PMV_CANDS list may first be used for coding of a motion vector MV associated with a first motion compensation block, then PMV_CANDS may be updated using the vector MV (e.g. MV is added into the list), and then used for coding of a second motion compensation block. By subsequently updating PMV_CANDS with coded motion vectors, the list is updated according to a sliding window approach.

During encoding of a video, one or multiple PMV_CANDS lists may be maintained according to the sliding window approach, e.g. one for each frame type, one for each macroblock type, or one for each reference frame. When coding the two motion vectors associated with a bi-predicted motion compensation block, either a single or two different PMV_CANDS lists may be used.

Before a motion vector associated with a current motion compensation block is processed, the PMV_CANDS list used for coding the current motion vector may be updated by using motion vectors associated with surrounding blocks.

The PMV_CANDS list may be updated such that motion vectors associated with close motion compensation blocks are inserted towards the beginning of the PMV_CANDS list (signaled with fewer bits), whereas motion vectors associated with more far away motion compensation blocks may be inserted towards the end of the PMV_CANDS list. Possible metrics to determine how far a motion compensation block is away from the current block include: the Euclidian distance (dx²+dy², where dx and dy are distances in the x and y directions, respectively), the Manhattan distance (the sum of absolute values, |dx|+|dy|), or the Chebyshev distance (the maximum of the absolute values, max(|dx|, |dy|), also known as maximum metric, chessboard distance, box distance, I_{∞}metric (L-infinity metric), or I_{∞}norm). To this end, an outwards going scan may be performed around the current block to obtain motion vectors to update PMV_CANDS. The scan may be terminated when at least one of the following conditions is met:
all blocks of the current frame have been scanned,
all blocks of a pre-defined number of subsequent frames (e.g. the last frame) have been scanned
once a certain distance has been reached,
as soon as a pre-defined number of unique PMV candidates have been found,
all blocks of a predetermined scan pattern have been scanned.

Note that sorting the list on distances may be avoided in an outwards going scan, by inserting unique vectors at the end of the PMV_CANDS list, the list is kept sorted with the spatially closest vector first in the list.

Motion vectors to be added to a PMV_CANDS list may comprise spatial or temporal neighbors of the current block, or combinations of spatial and/or temporal neighbors, e.g. a H.264/AVC-style median predictor derived based on spatially neighboring blocks.

As an alternative to consideration of a pre-defined neighborhood to scan for motion vector candidates, it may be signaled from encoder to decoder (and thus dynamically decided at the encoder), for each motion vector or for a set of motion vectors (e.g. a macroblock), whether the associated motion vectors are to be added to the PMV_CANDS list.

Out of a set of possible mechanisms for determining motion vector candidates, one or a combination of mechanisms may be dynamically decided at the encoder and the decision then signaled to the decoder.

Limiting and/or reducing the number of candidates in PMV_CANDS can be helpful to reduce the overhead of signaling which PMV is used for motion vector prediction, since shorter lists require shorter code words. Additionally, restricting the addition of certain candidates can make room for other, more beneficial candidates to be added.

One measure for reducing the number of candidates is to avoid duplicate occurrences of the same motion vector in a given PMV_CANDS list. This can be done, when updating the list, by comparing the candidates already in the list with the new vector that could be added, and if a duplicate is found, either removing the duplicate vector or skipping the new vector. It is preferable to skip the new vector; otherwise a subsequent duplicate from a distant block may cause a candidate high in the order of the list to be put at the end of the list.

Removing or skipping new motion vectors may likewise be done for motion vectors that are similar but not equal, such as pairs of motion vectors that have a similarity measure smaller than a pre-defined threshold, where similarity measures could be Euclidian distance (x₀−x₁)²+(y₀−y₁)² or absolute distance |xₒ−x₁|+|y₀−y₁|, with (x₀,yₒ) and (x₁,y₁) being the pair of motion vectors under consideration. Rather than a straight distance measure, another approach is to look at the number of bits required to encode the distance between the motion vectors using a given encoding scheme.

Also, the number of candidates in PMV_CANDS may be limited to a pre-defined or dynamically obtained number. It is possible that once the number has been reached an additional candidate is to be added, then the candidate at the end of the PMV_CANDS list may be removed. This can be done because the candidate list is sorted such that the PMV candidate at the end of the list has been determined to be the least likely to be used.

Alternatively, removal of candidates from a PMV_CANDS list may be signaled explicitly from the encoder to the decoder (and thus decided dynamically by the encoder), e.g. by sending a code for removal of a motion vector candidate from a list along with an identifier of the motion vector, e.g. an index.

How to determine the order of motion vector candidates in candidate list will now be addressed. It is assumed that the candidates in PMV_CANDS are sorted, and use of one of the candidates in PMV_CANDS for prediction is signaled such that the first candidate in the list is assigned the shortest code word among the candidates and that subsequent candidates in the list are assigned code words with non-decreasing length. The following methods can be used when updating a PMV_CANDS list in order to sort the candidates in a way that is beneficial for overall coding efficiency.
The motion vectors corresponding to blocks that are close to the current block (using some distance metric) will get a position closer to the start of the list compared to motion vectors belonging to blocks that are further away from the current block.
The motion vector associated with the last coded block is placed at the beginning of the list (shortest code word). Alternatively, a combined candidate such as an H.264/AVC median predictor (or the like) for the current block is placed at the beginning of the list. Combining this approach with dynamic adaptation of PMV_CANDS list size allows guaranteed prediction performance of e.g. the H.264/AVC median predictor, since it is possible that PMV_CANDS list size is set to one, such that no bits need to be sent for index signaling.
The candidates can be sorted according to frequency of occurrence of the candidate (or other candidates with e.g. Euclidian or absolute distance below a pre-defined threshold) in previously coded blocks, such that vectors that describe typical motion in a video frame or sequence are assigned short code words. Alternatively, if a duplicate of a new candidate is already in the list, then the duplicate can be removed, and the new vector added at the beginning of the list, or as a further alternative the existing motion vector can be moved upwards one or more steps in the list.
It can further be useful to include weight with respect to motion compensation partition size, such that motion vectors with more weight are placed farther in the beginning of a PMV_CANDS list than those with lower weight. For instance, larger partitions could be trusted more than smaller partitions in the sense that the associated motion vectors may, depending on the coded sequence, more likely describe typical motion in that sequence. Thus motion vectors associated with larger partitions may be assigned more weight. Also, skip motion vectors may be trusted differently, e.g. assigned less weight, compared to non-skip motion vectors.

Alternatively, resorting of a PMV_CANDS list may be signaled explicitly from the encoder to the decoder (and thus decided dynamically by the encoder), e.g. by sending a code for resorting of a motion vector candidate from a list along with an identifier of the motion vector to be moved, e.g. an index, and a signal about where to move that candidate.

At the time when a motion vector candidate is added to or obtained from a PMV_CANDS list (in the latter case, in order to use it for prediction), it may be modified according to a pre-defined method. Since modification at time of adding (during encoding) or obtaining (during decoding) is equivalent, it may without loss of generality be assumed that vectors are modified at the time of obtaining. Such modifications at the time of obtaining may include:
Scaling of a motion vector candidate according to the frame distance of the reference frame to which the motion vector candidate is applied for prediction. For example, assume a candidate motion vector MV_{(T-1)}=(X,Y) in PMV_CANDS that has been applied for motion compensated prediction from a reference frame representing the video at time T−1, which is next to the current frame that is assumed to represent the video at time T. Now if this candidate is obtained from PMV_CANDS to be used for prediction of a motion vector pointing to a reference frame representing the video at time T−2 (two frames next to the current frame), then the motion vector magnitude can be scaled by a factor of 2, i.e. (2*X,2*Y). Also, if a candidate motion vector (X,Y) in the PMV_CANDS list refers to the video frame at T−2 is to be used for referencing the frame at T−1, the motion vector can be scaled to (X/2,Y/2). For both these cases we may end up duplicating a candidate motion vector in which case it can be removed. Scaling of candidate motion vectors is reasonable under the assumption of linear motion.
Similarly, when obtaining a motion vector predictor MV_{(T-1)}=(X,Y) in a B frame that represents time T, and that motion vector has been applied for motion compensated prediction from a left reference frame (time T−1), and now the predictor is to be used for prediction of a vector applied for motion compensated prediction from a right reference frame (time T+1), then the sign of the motion vector predictor is inverted, i.e. (−X,−Y).

The candidate predictor list size can be varied. Limiting and/or reducing the number of candidates in PMV_CANDS can be helpful to reduce the overhead of signaling which PMV is used for motion vector prediction, since shorter lists require shorter code words. On the other hand, depending on video sequence characteristics, it may be beneficial to have a larger number of motion vector prediction candidates e.g. in order to save bits for DMV coding in case of irregular motion. The following methods can be used to adapt the size of PMV_CANDS list according to video sequence characteristics.
The list size can be defined in the slice/frame/picture header or in a sequence-wide header (such as parameter set), i.e. signaled from the encoder to the decoder, and thus dynamically adapted by the encoder.
Candidates that have not been used for prediction during encoding of a number of previously coded blocks (according to a pre-defined threshold) can be removed from the list, thus reducing the list size.
The list size may be adapted according to similarity of candidates in the list. For example, when updating a list with a motion vector MV, the number of candidates that are similar to MV (according to a distance measure such as Euclidian or absolute distance, with a pre-defined threshold) are counted. A high count indicates a high number of similar candidates, and since it may not be necessary to have many similar candidates, at least one may be removed and the list size reduced. A low number of similar candidates on the other hand may indicate that it may be beneficial to have an additional candidate, thus the list size may be increased.

As mentioned above, the candidates in PMV_CANDS are sorted and the use of one of the candidates in PMV_CANDS is signaled such that the first candidate in the list is assigned the shortest code word among the candidates and that subsequent candidates in the list are assigned code words with non-decreasing length. Such code words can be defined e.g. according to Variable Length Coding (VLC) tables. The VLC table used can depend on the maximum number of candidates in PMV_CANDS (the list size), as e.g. dynamically adapted according to the methods above. Table 1 below presents some examples for VLC codes for different maximum list sizes. The left column shows the maximum list size, also denoted as C. In the right column, the VLC codes are shown along with indexes to address candidates in the PMV_CANDS list.

TABLE 1
Example VLC codes for different maximum list sizes.

| Maximum | |
|---|---|
| list | |
| size C | Index: VLC code |
| | 0:-(unambiguous, no signaling necessary) |
| 2 | 0: 0 |
| | 1: 1 |
| 3 | 0: 1 |
| | 1: 00 |
| | 2: 01 |
| 4 | 0: 1 |
| | 1: 00 |
| | 2: 010 |
| | 3: 011 |
| 5 | 0: 1 |
| | 1: 00 |
| | 2: 010 |
| | 3: 0110 |
| | 4: 0111 |
| 6 | 0: 1 |
| | 1: 010 |
| | 2: 011 |
| | 3: 001 |
| | 4: 0000 |
| | 5: 0001 |
| 7 | 0: 1 |
| | 1: 010 |
| | 2: 011 |
| | 3: 0010 |
| | 4: 0011 |
| | 5: 0000 |
| | 6: 0001 |

For bi-predicted motion compensation blocks, two motion vectors are coded, and thus two PMV candidates can be necessary. In that case the index numbers for the two PMV candidates can be coded together to further reduce the number of bits required for index coding. Table 2 shows an example for joint index coding, considering that both motion vectors use the same PMV_CANDS list, and that it is likely that both motion vectors use the same predictor in the PMV_CANDS list. Here idx0 and idx1 denote the indexes for first and second predictor, respectively. VLC0(idx,C) denotes a VLC for an index “idx” according to Table 1 considering a maximum list size of C.

TABLE 2
VLC code for coding of two candidates indexes
associated with bi-predicted block,
C: maximum size of PMV_CANDS.

| Case | VLC code |
|---|---|
| idx1 < idx0 | VLC0(idx0,C) 0 VLC0(idx1 , C-1) |
| idx1 = idx0 | VLC0(idx0,C) 1 |
| idx1 > idx0 | VLC0(idx0,C) 0 VLC0(idx1-1 , C-1) |

Unnecessary PMV candidates are removed from the list of PMV candidates. A mechanism for removing PMV candidates is required because it may happen that some candidates in the list will never be used, since choosing a candidate with a shorter codeword and encoding the distance will give a bit sequence that is shorter or of the same length compared for all possible motion vectors. In that case, they can be removed, thereby making the list shorter and the average bit length of each index shorter. As an alternative, it may be possible to instead insert more candidates. This way, the average bit length is kept the same, but the newly inserted candidate has a chance of being useful.

As an example, assume we have the following candidates:

| Value | Index | Code |
|---|---|---|
| (−1, 2) | 0 | 1 |
| (13, 4) | 1 | 010 |
| (12, 3) | 2 | 011 |
| (0, 2) | 3 | 0010 |
| (3, 4) | 4 | 0011 |
| (−4, 1) | 5 | 0000 |
| (4, 8) | 6 | 0001 |

Also, assume that we encode a difference, DMV, (xdiff, ydiff) where xdiff and ydiff are encoded using Table 3 below. If we want to encode a motion vector, such as MV=(0,2), we can then encode it using candidate 3, which is PMV=(0,2), plus a difference DMV=(0,0):

PMV+DMV=MV

(0,2)+(0,0)=(0,2).

The index costs four bits (the code length for index 3 is four bits), and each of the zeroes in the difference cost one bit, so the total number of bits required to code MV=(0,2) is 4+1+1=6 bits.

However, we can also code the vector using index 0, PMV=(−1,2), plus a difference DMV=(1,0):

(−1,2)+(1,0)=(0,2).

The index costs one bit (the code length for index 1 is one bit), the xdiff=1 term in the difference costs three bits (see Table 3 below) and the ydiff=0 term costs one bit. Hence we get 1+3+1=5 bits in total, which is better than using index 3, which required 6 bits. It is easy to see given that the vector difference is coded using Table 3 below, that it will never be beneficial to use index 3, because using index 0 will always be one bit cheaper or better. Hence we can eliminate the candidate vector (0,2) and we get instead:

| Value | Index | Code |
|---|---|---|
| (−1, 2) | 0 | 1 |
| (13, 4) | 1 | 010 |
| (12, 3) | 2 | 011 |
| (3, 4) | 4 | 001 |
| (−4, 1) | 5 | 0000 |
| (4, 8) | 6 | 0001 |

Index 4, vector (3,4) now has a shorter code; it is now three bits instead of four. Hence we have gained from the elimination if the vector (3,4) is used, and never lost anything. In the above example we removed the PMV candidate with index number 3, but it should be evident for a person skilled in the art that this is just an example. For instance, it may in some cases be beneficial to remove candidates 1 and 2 as well.

Since the same analysis is performed both in the encoder and the decoder, the same vector is removed from the list both in the encoder and the decoder. Hence, after the removal, both the encoder and the decoder will use the same candidate list.

Sometimes it may not be possible to ensure a gain by removing a single candidate, but it may be possible if two or more candidates are eliminated simultaneously. Another possibility is that altering the order of the candidates or even adding a new candidate to the list can allow us to remove candidates that have now been rendered unnecessary, and therefore be beneficial regardless of the final motion vector to be encoded.

TABLE 3
The cost of sending the differential

| Differential | Code |
|---|---|
| 0 | 1 |
| −1 | 010 |
| 1 | 011 |
| −2 | 00100 |
| 2 | 00101 |
| −3 | 00110 |
| 3 | 00111 |
| −4 | 0001000 |
| 4 | 0001001 |
| . . . | . . . |

The number of bits needed can be further reduced by not sending the sign bit, this is possible because in some circumstances the sign bit for the differential is unnecessary. Assume for example that we have the following list of PMV candidates:

| Value | Index | Code |
|---|---|---|
| (−1, 2) | 0 | 1 |
| (13, 8) | 1 | 010 |
| (3, 4) | 2 | 011 |
| (11, 3) | 3 | 0010 |
| (12, 3) | 4 | 0011 |
| (1, 2) | 5 | 0000 |
| (4, 8) | 6 | 0001 |

Assume that we want to encode a vector using PMV candidate having index number 3, PMV=(11,3). Since the PMV candidate with index number 4 is to the right of it (having coordinates PMV=(12,3)), it is advantageous to encode it with candidate 4 instead if the x-coordinate is 12 or greater. As an example, the vector MV=(15,2) can be encoded using candidate 3 as

(11,3)+(4,−1)

costing four bits for the index, seven bits for +4 and three bits for −1 (see table 3), in total 14 bits. But it can also be encoded using candidate 4 as

(12,3)+(3,−1)

this costs four bits for the index, five bits for +3 and three bits for −1, in total 12 bits. Since candidate 4 will always be closer to any point in the right half-plane, it will be advantageous to choose candidate 4 for that. Likewise, it is better to choose candidate 3 if we are in the left half-plane (as seen from the point between (11,3) and (12,3)).

This means that it is unnecessary to specify the sign bit for the differential in the x-component, since it will always be negative for (11,3) and positive for (12,3). The sign bit is the last bit in Table 3, except for 0 which does not have a sign bit. This means that if either candidate 3 or 4 will be selected, they will be one bit cheaper to encode.

The decoder will of course do the same analysis and avoid reading the sign bit if the above situation has occurred.

Even if the candidates are not exactly next to each other, or if they do not have exactly the same cost, it may be possible to avoid sending the sign bit, at least for one of the candidates. As an example, assume we want to encode a value using PMV candidate with index number 5, PMV=(1,2). If the x-coordinate for the vector to encode is smaller than or equal to zero, it is always advantageous to instead use candidate 0, since it has a lower cost. This means that the sign bit for the x-coordinate does not have to be sent for candidate 5. However, it may not be possible to remove the sign bit for the x-component for candidate 0. Since its index value is so inexpensive to code, it may be advantageous to choose it even if the vector to code is to the right of candidate 5.

If index 0 had the same cost as index 4, both candidates would be equally good to encode a vector with an x-coordinate of 0. However, we could decide to always use the lowest index in such cases, and thus still avoid sending the sign bit when index 4 is selected. If the vectors are in the same row (as above), or indeed in the same column, it is possible to derive a general expression for when it is never useful to send the sign bit, as follows.

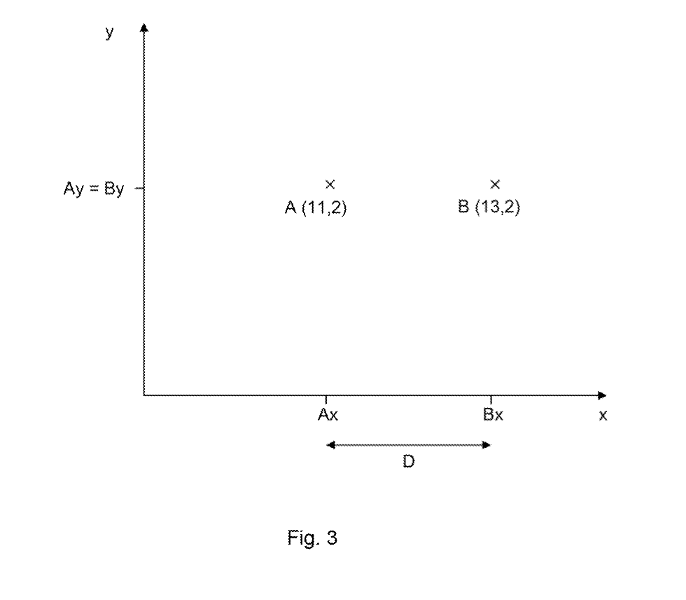

Referring to FIG. 3, assume that we have two candidates A=(Ax, Ay) and B=(Bx, By) on the same row (so By=Ay) and that the distance between them is D so that Bx=Ax+D. In the following we will assume that D is positive, but a person skilled in the art will appreciate that it also works if we switch places for A and B. Assume further that it is never more costly to transmit the index for candidate A than B, i.e., cost(A_index)<=cost(B_index), where cost(A_index) is the cost of transmitting the index associated with candidate A. Denote the cost of sending the differential k in the x-direction cost_x(k). For instance, cost_x(−3) equals 5 according to Table 3.

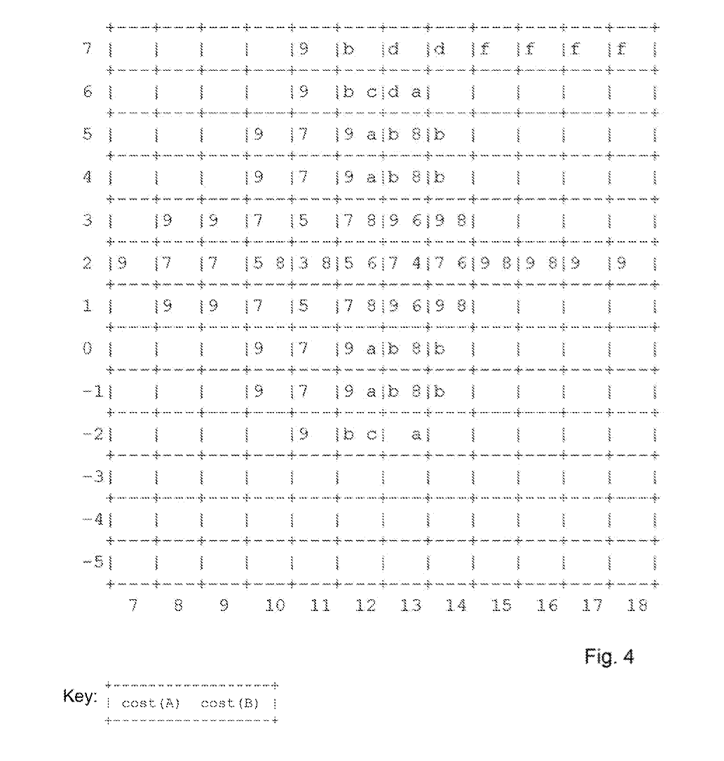

Now, if cost(A_index)−cost(B_index)+cost_x(D−1)−3<=0, we do not have to send the sign bit for candidate B. As an example, if A=(11,2), B=(13,2) and A_index is 1 and B_index is 0001, then D=2 and cost(A_index)−cost(B_index)+cost_x(D−1)−3 equals 1−4+3−3=−2 which is smaller than 0, hence we do not need to send the sign bit for B. This example is illustrated in FIG. 4, where the x and y axis show x and y components of motion vectors. Each box in FIG. 4 represents a motion vector; the bit cost of coding the respective motion vector using PMV candidate A is shown to the left of the box and the bit cost of coding the respective motion vector using PMV candidate B is shown to the right of the box. From FIG. 4 it can be seen that for MVs with an x component of 12 or less the most efficient PMV to use is A, whereas for MVs with an x component of 13 or more, the most efficient PMV to use is B.

In one embodiment of the proposed solution, we use a maximum of four candidates in the list. However, in another embodiment, we use seven, and there is in principle no limit to the maximum. If we allow for a bigger maximum, the list can grow and chances increase that a suitable vector can be found. On the other hand, the number of bits needed to specify the candidate vector also increases. On top of that we get the problem that many vectors can be represented using several candidates, which is unnecessary. This redundant representation grows the more vectors are added.

One way to avoid this redundant representation is to restrict the number of vectors that it is possible to encode with each candidate vector. For example, it is possible to restrict a certain candidate so that it can only encode motion vectors that are exactly equal to the candidate, or differs in one step in one direction. This can be done by changing the way the differential is encoded. Usually the differential is encoded using Table 3, with separate encoding for x and y. Instead, we could use the following short table:

| Differential | Code |
|---|---|
| (0, 0) | 1 |
| (−1, 0) | 000 |
| (0, −1) | 001 |
| (1, 0) | 010 |
| (0, 1) | 011 |

This restricted coding of the differential may be employed for candidates above a certain index. For instance, all candidates with index 3 or higher could be encoded this way.

This has at least two advantages:

1) The coding of the differential becomes very short, which is good since the cost of signaling index 3 or higher is quite high; and
2) The candidate will not spend bits on covering motion vectors that would anyway be better encoded using some of the other candidate vectors. The redundancy problem described above is thereby ameliorated.

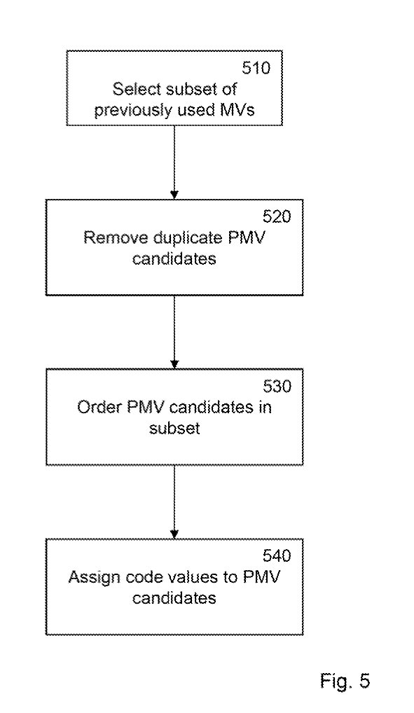

FIG. 5 illustrates a method according to the present application. At 510 a set of PMV candidates is selected from the set of previously used motion vectors. The previously used motion vectors are those that have been used during coding of a previous block in the frame. At 520, duplicate PMV candidates may be removed from the set. At 530, the PMV candidates in the set are ordered according to expected usage. Expected usage may be calculated based on recently coded video. Expected usage may be determined from the proximity of the current block to the block for which the PMV candidate was used as a motion vector, using some distance measure. At 540, code values are assigned to PMV candidates, the code values varying in length. The shortest code value is assigned to the PMV candidate having the highest expected usage. Subsequent code values have a non-decreasing length.

The methods and apparatus described herein improve coding efficiency for motion vector prediction schemes that use signaling of motion vector predictor.

It will be apparent to the skilled person that the exact order and content of the actions carried out in the method described herein may be altered according to the requirements of a particular set of execution parameters. Accordingly, the order in which actions are described and/or claimed is not to be construed as a strict limitation on order in which actions are to be performed.

Further, while examples have been given in the context of particular coding standards, these examples are not intended to be the limit of the coding standards to which the disclosed method and apparatus may be applied. For example, while specific examples have been given in the context of H.264/AVC, the principles disclosed herein can also be applied to an MPEG2 system, other coding standard, and indeed any coding system which uses predicted motion vectors.

1. A method of managing Predicted Motion Vector candidates (PMV candidates), the method comprising:
selecting a set of PMV candidates as a subset of previously coded motion vectors;
assigning a code value to each PMV candidate in the set of PMV candidates, wherein the code values vary in length and are assigned to the PMV candidates in order of expected usage such that the PMV candidate having the highest expected usage has one of the shortest code values.

2. The method of claim 1, wherein the code values assigned to each PMV candidate are assigned according to at least one of:
arithmetic coding;
Variable Length Coding; and
Context-Based Adaptive Arithmetic Coding.

3. The method of claim 1, the method further comprising removing unnecessary PMV candidates from the set of PMV candidates.

4. The method of claim 1, the method further comprising sorting the PMV candidates in the set of PMV candidates according to expected usage.

5. The method of claim 1, wherein the expected usage of a PMV candidate is obtained from the frequency of use of PMV.

6. The method of claim 1, wherein each PMV candidate corresponds to a motion vector used for coding of a previous block, said previous block having a distance from a current block, and wherein the expected usage of a PMV candidate is obtained from the distances of their respective previous blocks from a current block.

7. The method of claim 6, wherein the distance is measured as a Euclidean distance.

8. The method of claim 6, wherein the distance is measured as a Chebyshev distance.

9. The method of claim 8, wherein the code values are assigned to PMV candidates having common Chebyshev distance according to their Euclidean distance.

10. The method of claim 1, the method for video encoding or for video decoding, wherein the current block is the block being encoded or decoded respectively.

11. A video encoding apparatus comprising a processor arranged to:
select a set of PMV candidates as a subset of previously coded motion vectors;
assign a code value to each PMV candidate in the set of PMV candidates, wherein the code values vary in length and are assigned to the PMV candidates in order of expected usage such that the PMV candidate having the highest expected usage has one of the shortest code values.

12. A video decoding apparatus comprising a processor arranged to:
select a set of PMV candidates as a subset of previously coded motion vectors;
assign a code value to each PMV candidate in the set of PMV candidates, wherein the code values vary in length and are assigned to the PMV candidates in order of expected usage such that the PMV candidate having the highest expected usage has one of the shortest code values.

13. A computer-readable medium, carrying instructions, which, when executed by computer logic, causes said computer logic to carry out the method of claim 1.
